(19) United States
(12) Patent Application Publication
(10) Pub. No.: US 2004/0075400 A1
(43) Pub. Date: Apr. 22, 2004

(54) Lighting module

(76) Inventor: Chih-Tsung Su, Shinjuang City (TW)

Correspondence Address: Chih-Tsung Su, P.O. Box No.6-57, Chung-Ho City, Taipei Hsien, 235, TW

(21) Appl. No.: 10/318,057

(22) Filed: Dec. 13, 2002

(30) Foreign Application Priority Data
Oct. 17, 2002 (TW) 091216527

(51) Int. Cl. G05F 1/00

(52) U.S. Cl. 315/291

(57) ABSTRACT

A lighting module is a non-spherical len and a plurality of LED circuit boards assembled together that the LED circuit board include various electronic cicuit components. The provision of electric power enables the LED having different kinds of color conversions and exchangable twinkling illuminations.

### BACKGROUND OF THE INVENTION

1) Field of the Invention

The present invention relates to a module, more particularly to a lighting module which can be applied to the fixtures such as flashlights and hazard lights.

2) Description of the Prior Art

Referring to FIG. 1 and FIG. 2, a perspective view and a perspective exploded view of a conventional flashlight is shown. The flashlight consists essentially of a plinth 17, at least a battery 19, a handle 18, a light bulb 16, a cup shade 13, and a smooth mirror 12. This is a common and well-known installation for a conventional lighting fixture on a flashlight 10, which is to turn on or turn off the light bulb 16 by a controlling switch 20.

Especially, the conventional flashlight 10 is by the design of the smooth mirror 12 which the light is reflected out through a reflector pasted or the way of plating being done on inside wall of the cup shade 13; the light is to emit directly through the smooth mirror 12 without any changes. The light is being not easy to astigmatism, focus, or having the problem of a weak strength.

### SUMMARY OF THE INVENTION

The primary objective of the present invention is to provide a lighting module, which consists of a non-spherical len and a circuit board with a plurality of LED assembled together that the circuit board with a plurlaity of LED therein includes various electronic circuit components. Electric power is provided to make the LED have different kinds of color conversions and exchangable twinkling illuminations.

The provided module of the present invention further includes an incrustation; by doing so, this lighting module can be applied widely to all kinds of lighting fixtures such as flashlights, hazard lights, traffic lights, outdoor lights, indoor lights, ect.

To enable a further understanding of the said objectives as well as other objectives and structure details of the invention herein, the detailed description of the invention along with the brief description of drawings below shall provide additional elaboration.

### BRIEF DESCRIPTION OF THE DRAWINGS

FIG. 1 is a cross-sectional view of a conventional flashlight.

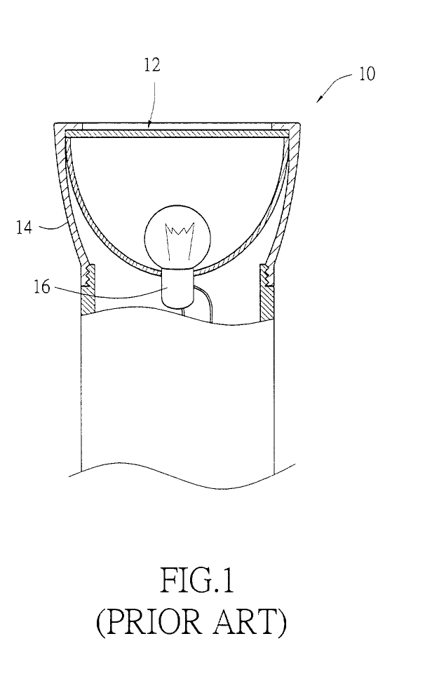

FIG. 2 is a perspective exploded view of the conventional flashlight.

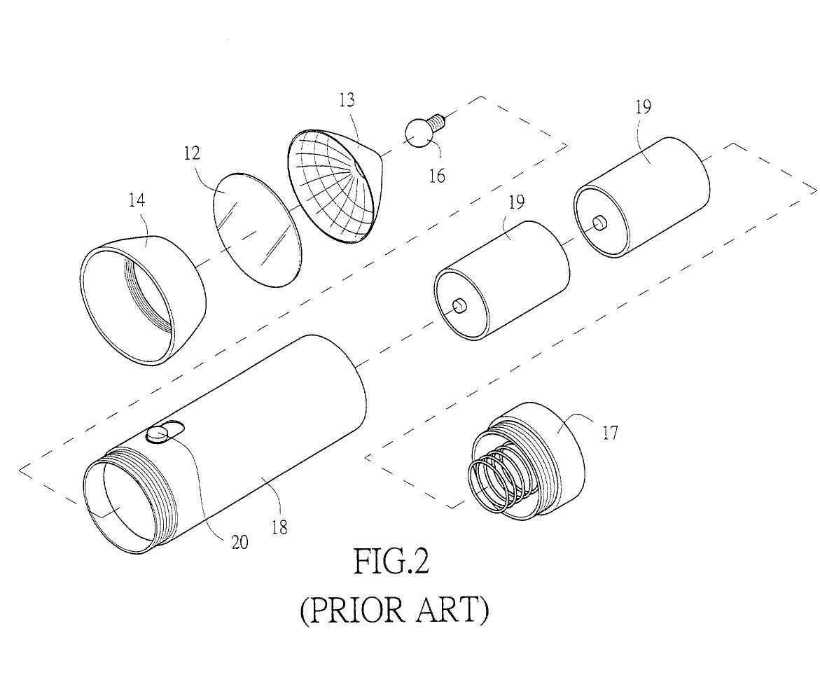

FIG. 3 is a perspective exploded view of a lighting module of the present invention.

FIG. 4 is a partial cross-sectional view of the present invention.

FIG. 5 is a perspective view of the preferred embodiment of the present invention.

### DESCRIPTION OF THE PREFERRED EMBODIMENTS

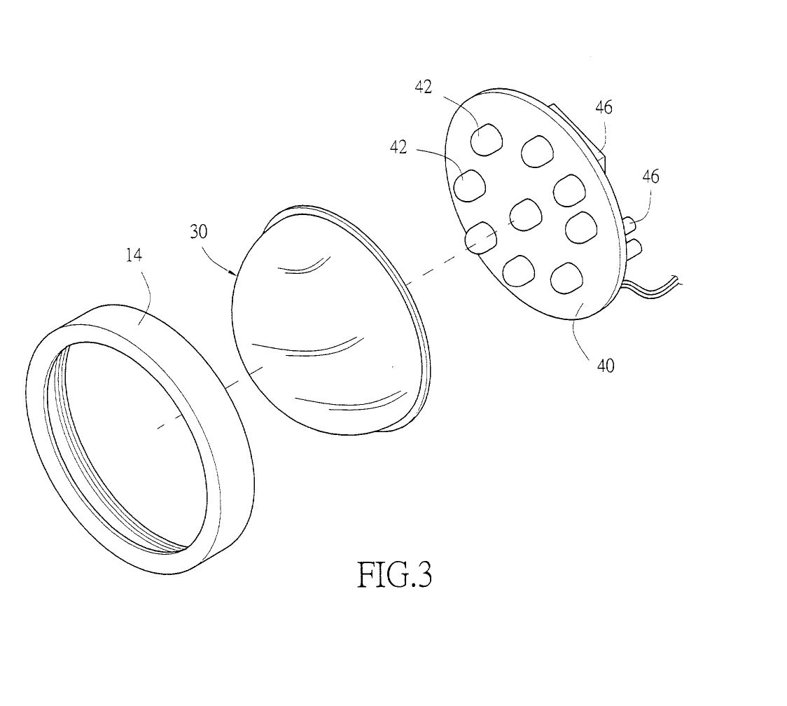

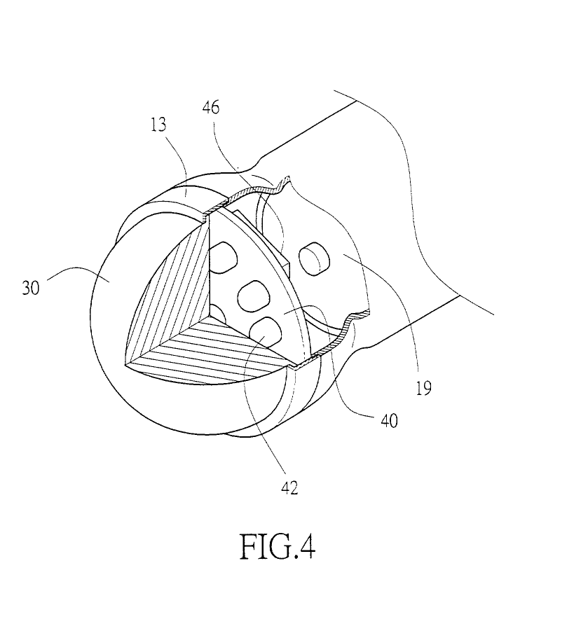

Referring to FIG. 3 and FIG. 4, a lighting module constructed in accordance with the present invention is illustrated. The lighting module includes a non-spherical ten 30 and a circuit board 40 with a plurality of LED assembled together, wherein the circuit board 40 with a plurality of LED further includes various electronic components 46. Power is supplied to the circuit board by a battery or a conventional power supply cord (not shown) enables the LED 42 having different kinds of color conversions and exchangable twinkling illuminations.

Yet another object of the present invention is to provide a lighting module with an incrustation 14. Referring to FIG. 4, the incrustation 14 fixly fastens the non-sperical len 30 and the circuit board 40 with a plurality of LED together in the front end of the flashlight 10. What needs to be emphasized is that the different kinds of color conversions and exchangable twinkling illuminations made by this invention has been well known, which would not be explained herein.

Also worthy of mention, the design of a non-spherical len 30 is to use a larger LED 42 with an elevation of 30° to 60° instead of a conventional elevation of 20° to 30°. Furthermore, the non-spherical len 30 is made by plastic or acrylic material, which allows the LED having the effect of centerizing, clustering, and strenthening the light (about 10 times). The len has a length of 10 mm, a radius of 50 mm, and a height of 38 mm.

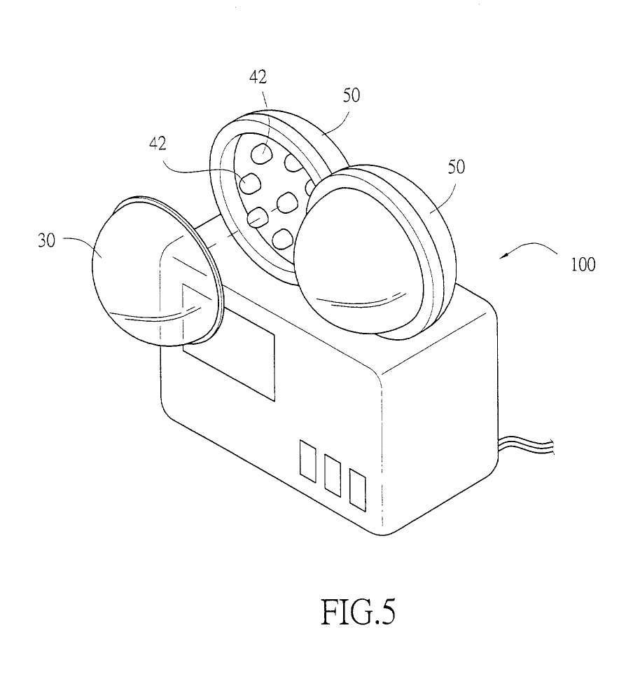

As seen in FIG. 5, the perspective view of another preferred embodiment of the present invention, a hazard light 100 includes a non-spherical len 30, a circuit board 42 being assembled inside an illumination shade 50; an adjacent illumination shade 50 next therto has the same construction. Overall, the construction of the hazard light is considered the same as the said flashlight 10 and thus the explanation is not repeated herein.

In summation of the foregoing sections, the present invention is explained with preferred embodiments. It is of course to be understood that the embodiments described herein are merely illustrative of the principles of the invention and that a wide variety of modifications thereto may be effected by persons skilled in the art without departing from the spirit and scope of the invention as set forth in the following claims.

1. A lighting module comprising a non-spherical len and a circuit board with a plurality of LED assembled together, wherein, the circuit board with a plurality of LED includes various electronic circuit components; the provision of electric power enables a plurality of LED having different kinds of color conversions and exchangable twinkling illuminations.

2. The lighting module in accordance with claim 1, wherein, the lighting module further includes an incrustation.

3. The lighting module in accordance with claim 1, wherein, the non-spherical len is made of plastic or acrylic materials.
